(19) United States
(12) Patent Application Publication
(10) Pub. No.: US 2011/0033294 A1
(43) Pub. Date: Feb. 10, 2011

(54) BLADE PITCH REGULATING HUB AND SPEED REGULATING GEAR FOR WIND DRIVEN POWER GENERATORS

(76) Inventor: Helmuth A. Geiser, Cape Coral, FL (US)

Correspondence Address: EDWARD M. LIVINGSTON, PA, 963 TRAIL TERRACE DRIVE, NAPLES, FL, 34103, US

(21) Appl. No.: 12/536,325

(22) Filed: Aug. 5, 2009

(51) Int. Cl. F03D 7/06

(52) U.S. Cl. 416/44; 416/131

(57) ABSTRACT

A blade pitch regulating hub (1) having a circular base (4) having a base gear (5) pivotally attached thereto. Blade stems (6) are placed equally apart from one another around the hub base. The blade stems have stem gears (7) that all engage the base gear so that all of the blade stems rotate at equal distances and in the same direction. The pitch of the blade stems and blades (8) are also controlled by the regulating means (2). A speed regulating gear (12) regulates the rotational power output from a wind driven power generator by using a telescoping housing (14) and conical gear (19) that extend and retract depending on wind speed. A guide means (20) ensures that a sliding gear assembly (26) always stays engaged with the conical gear as the diameter of the conical gear changes as it retracts and extends. An output gear assembly (28) engages the sliding gear assembly and transfers power from the sliding gear assembly to an output axle (29).

### BACKGROUND OF THE INVENTION

This invention relates to wind driven power generators, more particularly, a wind driven power generator having a blade pitch regulating hub that automatically adjusts the pitch and feathers wind turbine blades to accommodate current wind speed and a speed regulating gear that automatically regulates the rotational speed of an output axle in order to maintain a consistent rotational speed regardless of changes in wind speed.

Wind driven power generators convert the kinetic energy of wind into mechanical energy and are used to harness and convert wind into electricity. A problem with wind driven power generators has always been the unpredictability of wind speeds at any given moment and the effect of those different wind speeds on a wind driven power generator. At low wind speeds there is not enough wind energy to turn the blades of a wind driven power generator fast enough to create the required amount of revolutions per minute (“RPM”) to create electricity. Alternatively, high wind speeds can damage the blades of a wind driven power generator and/or the internal working of the wind driven power generator by creating to many RPM. Further, wind speed in not always constant and may come in small gusts that are hard to capture. Current solutions to these problems have been to use electronic sensors to measure wind speed and then feather or adjust the pitch of a wind driven power generator's blades so that the blades capture more wind or less wind. A problem with this method is that the electronic sensors are expensive and therefore not easily adaptable to smaller wind driven power generators. An additional problem with current electronic sensors is that the sensors do not react and turn the blades of a wind driven power generator fast enough to capture wind gusts. An even further problem is the damage caused to the blades and to the wind driven power generator in high speed winds because the electronic sensors do not ensure that the blades are always feathered simultaneously and at equal angles. An even further problem is the amount of torque placed on a drive shaft in high winds. If the amount of torque is too high it can cause damage to the wind driven power generator.

Therefore, a need exists for a pitch regulating hub and speed regulator gear for wind driven power generators that will automatically adjust the pitch and feather the blades of a wind driven power generator simultaneously and evenly and will control the rotational speed of an output axle, thereby preventing damage to the wind driven power generator and optimizing the amount of electricity created by the wind driven power generator.

The relevant prior art includes the following references:

| Pat. No. | | |
|---|---|---|
| (U.S. unless stated otherwise) | Inventor | Issue/Publication Date |
| 2009/0058094 | Jansen et al. | Mar. 05, 2009 |
| 2009/0035133 | Ferman | Feb. 05, 2009 |
| 7,172,392 | Wastling et al. | Feb. 06, 2007 |
| 7,066,709 | Kim et al. | Jun. 27, 2006 |
| 6,320,273 | Nemec | Nov. 20, 2001 |
| WO98/02329 | Lloyd et al. | Jan. 22, 1998 |
| D386,991 | Carlson | Dec. 02, 1997 |
| 5,213,470 | Lundquist | May 25, 1993 |
| 4,877,374 | Burkett | Oct. 31, 1989 |
| 4,522,564 | Carter, Jr. et al. | Jun. 11, 1985 |
| 4,257,740 | Duez | Mar. 24, 1981 |
| 2,666,149 | Fumagalli | May 01, 1947 |
| 2,516,576 | Jacobs | Jan. 04, 1947 |
| 2,215,413 | Weeks | Aug. 24, 1937 |

### Non-Patent Documents

“Variable Pitch Wind Turbine,” Maasen Sustainable, Ltd., found at: http://www.maassen.ie/home/index.php?id=54

### SUMMARY OF THE INVENTION

The primary object of the present invention is to provide a blade pitch regulating hub that automatically feathers the blades of a wind driven power generator to accommodate changes in wind speed.

A further object of the present invention is to provide a speed regulating gear for wind driven power generators that controls the rotational speed of an output axle.

Another object of the present invention is to provide a blade pitch regulating hub and speed regulating gear for wind driven power generators that allows a wind driven power generator to capture wind gusts.

An even further object of the present invention is to provide a speed regulating gear for wind driven power generators that will autmoatically disengage the speed regulating gear in high winds, thereby preventing any damage to the wind driven power generator.

The present invention fulfills the above and other objects by providing a blade pitch regulating hub and speed regulating gear for wind driven power generators. The blade pitch regulating hub has a circular hub base with a circular bevel gear pivotally attached thereto. Blade stems are placed equally apart from one another around the hub base and extend outward form the center of the hub base through a hub wall. The blade stems have stem gears which are circular bevel gears located on one end. All of the stem gears engage the base gear so that if one blade stem rotates in a certain direction then the base gear will rotate, thereby rotating all of the blade stems equally. As wind blows, pressure is applied to blades that extend outward from the blade stems causing the blades and blade pitch regulating hub to rotate. As wind increases in speed, the pitch of the blades is increased to compensate for the increased pressure on the blades thereby maintaining constant revolutions per minute (“RPM”). The base gear and stem gears ensure that the pitch of the blades are feathered simultaneously and the pitch of all of the blades are always equal to each other. The pitch is also controlled automatically by a regulating means, such as a torsion bar or a helical spring. If there is an even number of blade stems, then the regulating means connects two of the base stems together. The two base stems connected by the regulating means are located 180 degrees apart from one another on the circular hub base. As wind increases in speed, the pitch of the blades is increased to compensate for the increased pressure on the blades. As the pitch of the blades is increased, the two blades connected by the regulating means rotate in opposite directions, thereby twisting the regulating means. As wind speed decreases the regulating means is untwisted, thereby rotating the blades in the opposite direction to decrease the pitch of all of the blades. If there is an odd number of blade stems, then the regulating means connects one of the base stems to the hub wall.

The speed regulating gear has a main housing having a telescoping housing extending therefrom. A stationary inner housing acts as a guide for the telescoping housing as the telescoping housing retracts and extends along the inner housing. An input axle connects to a mounting bracket located on one end of the telescoping housing and then extends through the telescoping housing, inner housing and ends in a conical gear. A regulating spring located inside of the telescoping housing and inner housing maintains the telescoping housing in an extended position when wind speeds are low and little or no pressure is being exerted on the telescoping housing. As wind speeds increase, the telescoping housing, input axle and conical gear all retract into the main housing. A guide means, such as a guide peg and projection having an angled guide slot, guide spring or a rack and pinion gear assembly, ensures that a sliding gear assembly always stays engaged with the conical gear as the diameter of the conical gear changes according to the position of the conical gear. An output gear assembly engages the sliding gear assembly and transfers power from the sliding gear assembly to an output axle. The speed regulating gear may be adapted to a upwind or downwind applications by reversing the direction of the conical gear.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of a blade pitch regulating hub of the present invention having an equal number of blade stems employing a torsion bar as a regulating means;

FIG. 2 is a front view of a blade pitch regulating hub of the present invention having an odd number of blade stems employing a helical spring as a regulating means;

FIG. 3 is a top partial cutaway view of a speed regulating gear of the present invention in a fully extended position having a guide slot and guide peg as a guide means;

FIG. 4 is a top partial cutaway view of a speed regulating gear of the present invention in a retracted position having a guide slot and guide peg as a guide means;

FIG. 5 is a top partial cutaway view of a speed regulating gear of the present invention having guide springs as a guide means;

FIG. 6 is a top partial cutaway view of a speed regulating gear of the present invention having a rack and pinion gear assembly as a guide means; and

FIG. 7 is a top view of a blade pitch regulating hub mounted on a speed regulating gear.

### DESCRIPTION OF THE PREFERRED EMBODIMENTS

For purposes of describing the preferred embodiment, the terminology used in reference to the numbered accessories in the drawings is as follows:
1. blade pitch regulating hub
2. regulating means
3. torsion bar
4. hub base
5. base gear
6. blade stem
7. stem gear
8. blade
9. axle
10. helical spring
11. hub wall
12. speed regulating gear
13. main housing
14. telescoping housing
15. inner housing
16. mounting bracket
17. regulating spring
18. input axle
19. conical gear
20. guide means
21. guide slot
22. guidepeg
23. guide spring
24. rack gear
25. pinion gear
26. sliding gear assembly
27. projection
28. output gear assembly
29. output axle
30. rack and pinion gear assembly

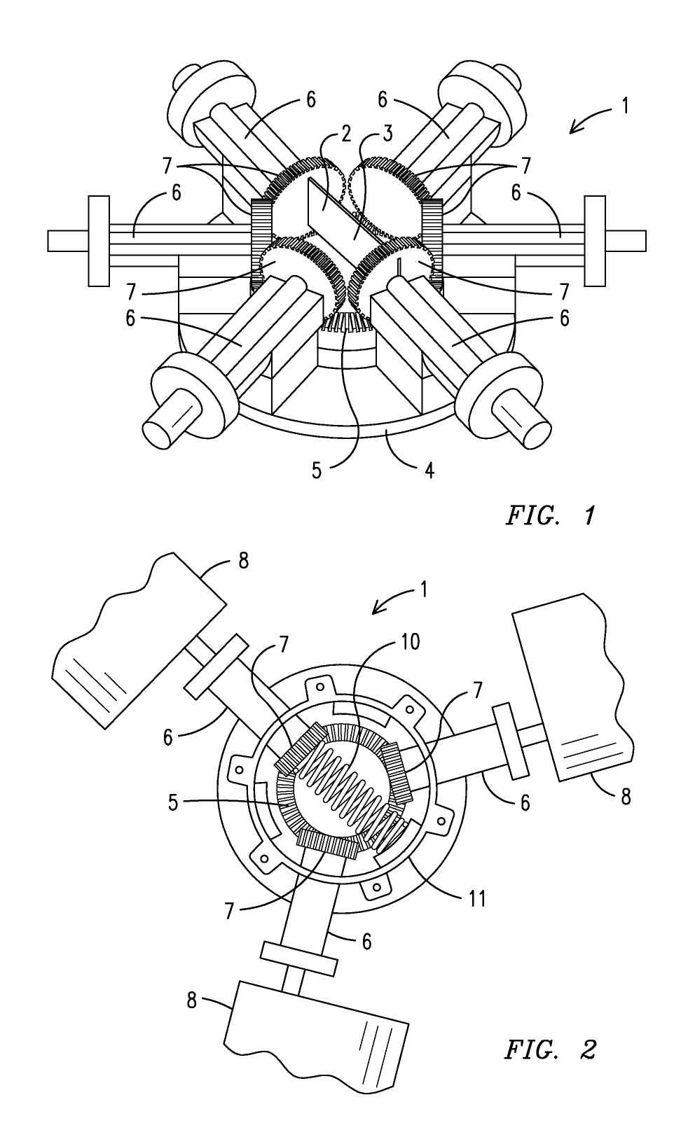

With reference to FIG. 1, a perspective view of a blade pitch regulating hub 1 of the present invention having an equal number of blade stems 8 employing a torsion bar 3 as a regulating means 2 is shown. The blade pitch regulating hub 1 comprises a circular hub base 4 having a base gear 5, which is a circular bevel gear, pivotally attached thereto. An equal number of blade stems 6 are placed equally apart from one another around the hub base 4 and extend outward form the center of the hub base 4 through a hub wall 11, as shown in FIG. 2. The blade stems 6 have stem gears 7, which are circular bevel gears, located on one end. All of the stem gears 7 engage the base gear 5 so that if one blade stem 6 rotates in a certain direction then the base gear 5 will rotate, thereby rotating all of the blade stems 6 equally. Blades 8 are attached to each of the blade stems 6 and the blades 8 extend outward from the blade stems 6, as shown in FIGS. 2, 7 and 8. As wind blows, pressure is applied to the blades 8, the blades 8 and blade pitch regulating hub 1 rotate, thereby causing an input axle 9 that is connected to the blade pitch regulating hub 1 to rotate as shown in FIG. 7. As wind increases in speed, the pitch of the blades 8 is increased to compensate for the increased pressure on the blades 8, thereby maintaining constant revolutions per minute (“RPM”) of the input axle 9. The base gear 5 and stem gears 7 ensure that the pitch of the blades 8 are feathered simultaneously and the pitch of all of the blades are always equal to each other. The angle of the pitch is also controlled automatically by the regulating means 2. The regulating means 2, which as shown here is a torsion bar 3, connects two of the base stems 6 together. The two base stems 6 connected by the torsion bar 3 are located 180 degrees apart from one another on the circular hub base 4. As wind increases in speed, the pitch of the blades 8 is increased to compensate for the increased pressure on the blades 8. As the pitch of the blades 8 is increased, the two blades 8 connected by the torsion bar 3 rotate in opposite directions, thereby twisting the torsion bar 3. As wind speed decreases the torsion bar 3 is untwisted, thereby rotating the blades 8 the opposite direction to decrease the pitch of the blades 8.

Now referring to FIG. 2, a front view of a blade pitch regulating hub of the present invention having an odd number of blade stems 8 employing a helical spring 10 as a regulating means 2 is shown. The blade pitch regulating hub 1 comprises a circular hub base 4 having a base gear 5, which is a circular bevel gear, pivotally attached thereto. An odd number of blade stems 6 are placed equally apart from one another around the hub base 4 and extend outward form the center of the hub base 4 through a hub wall 11. The blade stems 6 have stem gears 7, which are circular bevel gears, located on one end. All of the stem gears 7 engage the base gear 5 so that if one blade stem 6 rotates in a certain direction then the base gear 5 will rotate, thereby rotating all of the blade stems 6 equally. Blades 8 are attached to each of the blade stems 6 and the blades 8 extend outward from the blade stems 6. As wind blows, pressure is applied to the blades 8, the blades 8 and blade pitch regulating hub 1 rotate, thereby causing an input axle 9 that is connected to the blade pitch regulating hub 1 to rotate, as shown in FIG. 7. As wind increases in speed, the pitch of the blades 8 is increased to compensate for the increased pressure on the blades 8, thereby maintaining constant revolutions per minute (“RPM”) of the input axle 9. The base gear 5 and stem gears 7 ensure that the pitch of the blades 8 are feathered simultaneously and the pitch of all of the blades are always equal to each other. The pitch is also controlled automatically by the regulating means 2. The regulating means 2, which as shown here is a helical spring 10, is placed between one of the base stems 6 and the hub wall 11. As wind increases in speed, the pitch of the blades 8 is increased to compensate for the increased pressure on the blades 8. As the pitch of the blades 8 is increased, the blade 8 connected by the hub wall 11 rotates thereby twisting the helical spring 10. As wind speed decreases the helical spring 10 is untwisted, thereby rotating the blade 8 connected to it in the opposite direction to decrease the pitch of all of the blades 8.

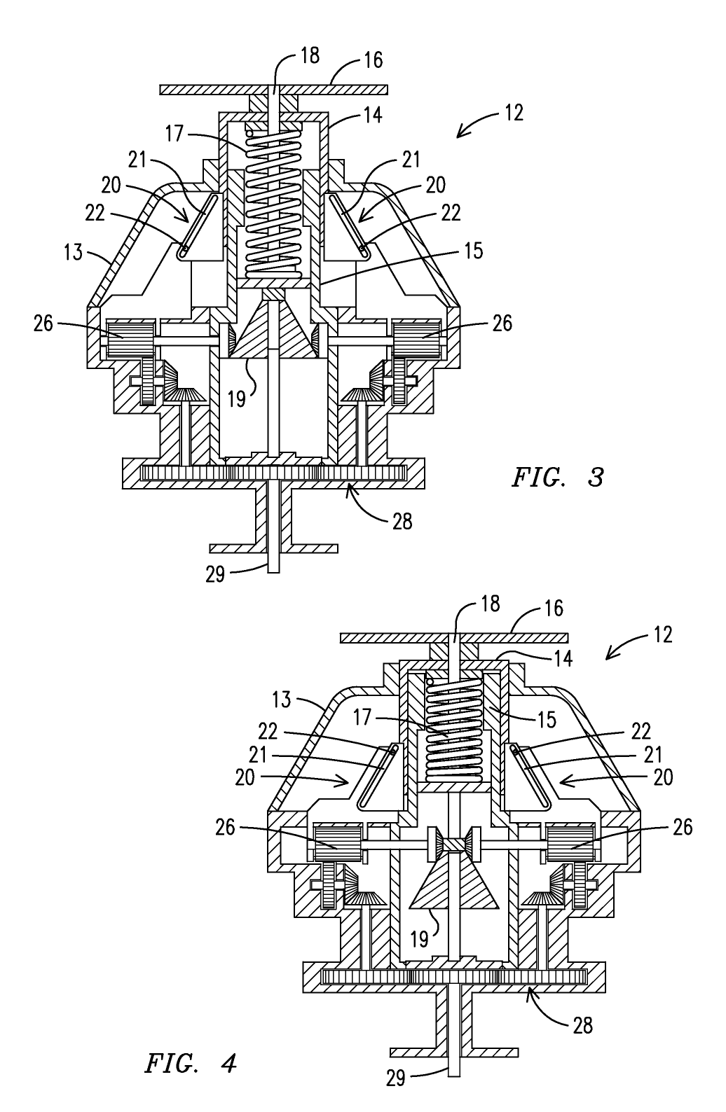

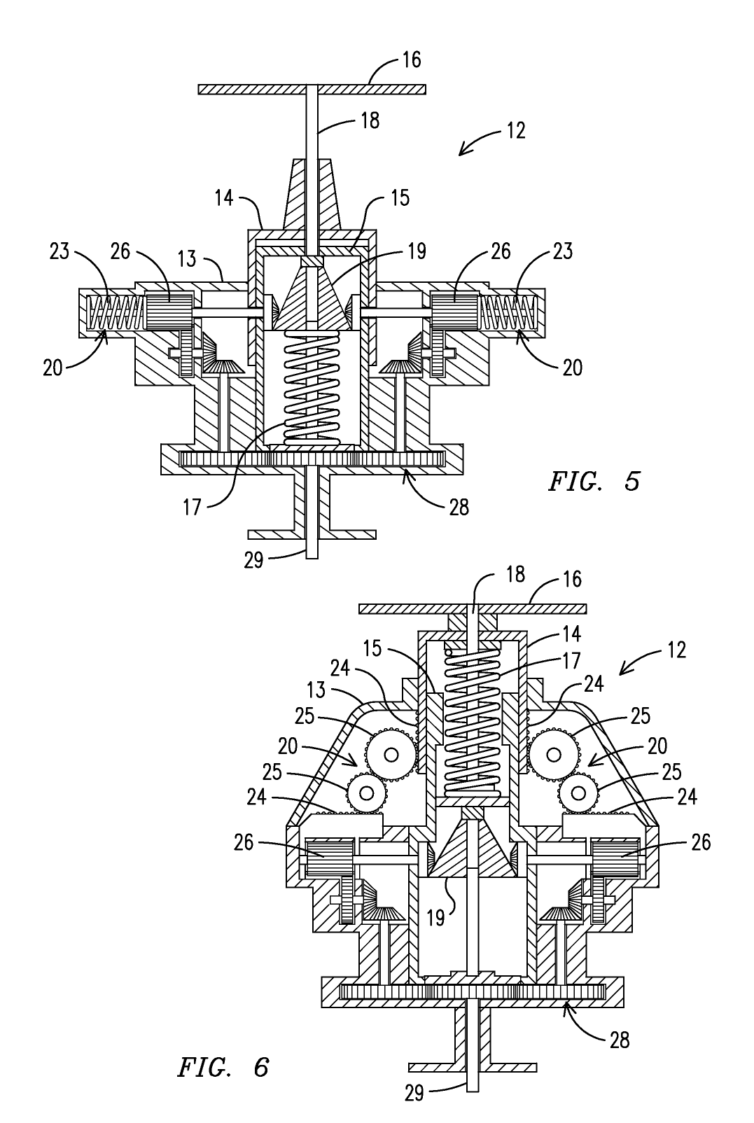

Now referring to FIG. 3, a top partial cutaway view of a speed regulating gear 12 of the present invention in a fully extended position having a guide slot 21 and guide peg 22 as a guides means 20 is shown. The speed regulating gear 12 comprises a main housing 13 having a telescoping housing 14 extending therefrom. A stationary inner housing 15 acts as a guide for the telescoping housing 14 as the telescoping housing 14 retracts and extends along the inner housing 15. A mounting bracket 16 is located on one end of the telescoping housing 14. The mounting bracket 16 is used for attaching a hub 1 to the speed regulating gear 12, as shown in FIG. 7. A input axle 18, which connects to the mounting bracket 16 extends through the telescoping housing 14, inner housing 15 and ends with a conical gear 19. A regulating spring 17 located inside of the telescoping housing 14 and inner housing 15 maintains the telescoping housing 14 in an extended position when wind speeds are low and little or no pressure is being exerted on the telescoping housing 14. As wind speeds increase, the telescoping housing 14, input axle 18 and conical gear 19 all retract within the main housing 13. A guide means 20, such as a guide peg 22 and projection 27 having an angled guide slot 21, guide spring 23 or a rack and pinion gear assembly 30, ensures that a sliding gear assembly 26 always stays engaged with the conical gear 19 as the diameter of the conical gear 19 changes according to the position of the conical gear 19 within the main housing 13. As shown here, the guide means 20 may be a one or projections 27 having angled guide slots 21 extending from the telescoping housing 14 and guide pegs 22 attached to the sliding gear assembly 26 that pass through the guide slots 21. As the telescoping housing 14 retracts inward, the guide slot 21 forces the guide peg 22 and the sliding gear assembly 26 to slide inward so that the sliding gear assembly 26 stays engaged with the conical gear 19 as the diameter of the conical gear 19 decreases, as illustrated in FIG. 4. After the telescoping housing 14 retracts past a certain point, the sliding gear assembly 26 will disengage from the conical gear 19 to prevent any harm to the speed regulating gear 1 and generator. As the telescoping housing 14 extends outward, the guide slot 21 forces the guide peg 22 and the sliding gear assembly 26 to slide outward so that the sliding gear assembly 26 constantly stays engaged with the conical gear 19 as the diameter of the conical gear 19 increases, as illustrated here. An output gear assembly 28 engages the sliding gear assembly 26 and transfers power from the sliding gear assembly 26 to an output axle 29. The speed regulating gear 12 may be adapted to a upwind or downwind applications by reversing the direction of the conical gear 19.

Now referring to FIG. 4, a top partial cutaway view of a speed regulating gear 12 of the present invention in a retracted position having a guide slot 21 and guide peg 22 as a guides means 20 is shown. The speed regulating gear 12 comprises a main housing 13 having a telescoping housing 14 extending therefrom. A stationary inner housing 15 acts as a guide for the telescoping housing 14 as the telescoping housing 14 retracts and extends along the inner housing 15. A mounting bracket 16 is located on one end of the telescoping housing 14. The mounting bracket 16 is used for attaching a hub 1 to the speed regulating gear 12, as shown in FIG. 7. A input axle 18, which connects to the mounting bracket 16 extends through the telescoping housing 14, inner housing 15 and ends with a conical gear 19. A regulating spring 17 located inside of the telescoping housing 14 and inner housing 15 maintains the telescoping housing 14 in an extended position when wind speeds are low and little or no pressure is being exerted on the telescoping housing 14. As wind speeds increase, the telescoping housing 14, input axle 18 and conical gear 19 all retract within the main housing 13. A guide means 20, such as a guide peg 22 and projection 27 having an angled guide slot 21, guide spring 23 or a rack and pinion gear assembly 30, ensures that a sliding gear assembly 26 always stays engaged with the conical gear 19 as the diameter of the conical gear 19 changes according to the position of the conical gear 19 within the main housing 13. As shown here, the guide means 20 may be a one or projections 27 having angled guide slots 21 extending from the telescoping housing 14 and guide pegs 22 attached to the sliding gear assembly 26 that pass through the guide slots 21. As the telescoping housing 14 retracts inward, the guide slot 21 forces the guide peg 22 and the sliding gear assembly 26 to slide inward so that the sliding gear assembly 26 stays engaged with the conical gear 19 as the diameter of the conical gear 19 decreases. After the telescoping housing 14 retracts past a certain point, the sliding gear assembly 26 will disengage from the conical gear 19 to prevent any harm to the speed regulating gear 1 and generator. As the telescoping housing 14 extends outward, the guide slot 21 forces the guide peg 22 and the sliding gear assembly 26 to slide outward so that the sliding gear assembly 26 constantly stays engaged with the conical gear 19 as the diameter of the conical gear 19 increases, as illustrated in FIG. 3. An output gear assembly 28 engages the sliding gear assembly 26 and transfers power from the sliding gear assembly 26 to an output axle 29. The speed regulating gear 12 may be adapted to a upwind or downwind applications by reversing the direction of the conical gear 19.

Now referring to FIG. 5, a top partial cutaway view of a speed regulating gear 12 of the present invention having guide springs 23 as a guide means is shown. The speed regulating gear 12 comprises a main housing 13 having a telescoping housing 14 extending therefrom. A stationary inner housing 15 acts as a guide for the telescoping housing 14 as the telescoping housing 14 retracts and extends along the inner housing 15. A mounting bracket 16 is located on one end of the telescoping housing 14. The mounting bracket 16 is used for attaching a hub 1 to the speed regulating gear 12, as shown in FIG. 7. A input axle 18, which connects to the mounting bracket 16 extends through the telescoping housing 14, inner housing 15 and through a conical gear 19. A regulating spring 17 located inside of the telescoping housing 14 and inner housing 15 maintains the telescoping housing 14 in an extended position when wind speeds are low and little or no pressure is being exerted on the telescoping housing 14. As wind speeds increase, the telescoping housing 14, input axle 18 and conical gear 19 all retract within the main housing 13. A guide means 20, such as a guide peg 22 and projection 27 having an angled guide slot 21, guide spring 23 or a rack and pinion gear assembly 30, ensures that a sliding gear assembly 26 always stays engaged with the conical gear 19 as the diameter of the conical gear 19 changes according to the position of the conical gear 19. As shown here, the guide means 20 is a guide spring 23 that pushes the sliding gear assembly inward toward the conical gear 19. As the telescoping housing 14 retracts inward, the guide spring 23 forces the sliding gear assembly 26 to slide inward so that the sliding gear assembly 26 stays engaged with the conical gear 19 as the diameter of the conical gear 19 decreases. After the telescoping housing 14 retracts past a certain point, the sliding gear assembly 26 will disengage from the conical gear 19 to prevent any harm to the speed regulating gear 1 and generator. As the telescoping housing 14 extends outward, the increased diameter of the conical gear 19 forces the sliding gear assembly 26 to slide outward so that the sliding gear assembly 26 constantly stays engaged with the conical gear 19. An output gear assembly 28 engages the sliding gear assembly 26 and transfers power from the sliding gear assembly 26 to an output axle 29. The speed regulating gear 12 may be adapted to a upwind or downwind applications by reversing the direction of the conical gear 19.

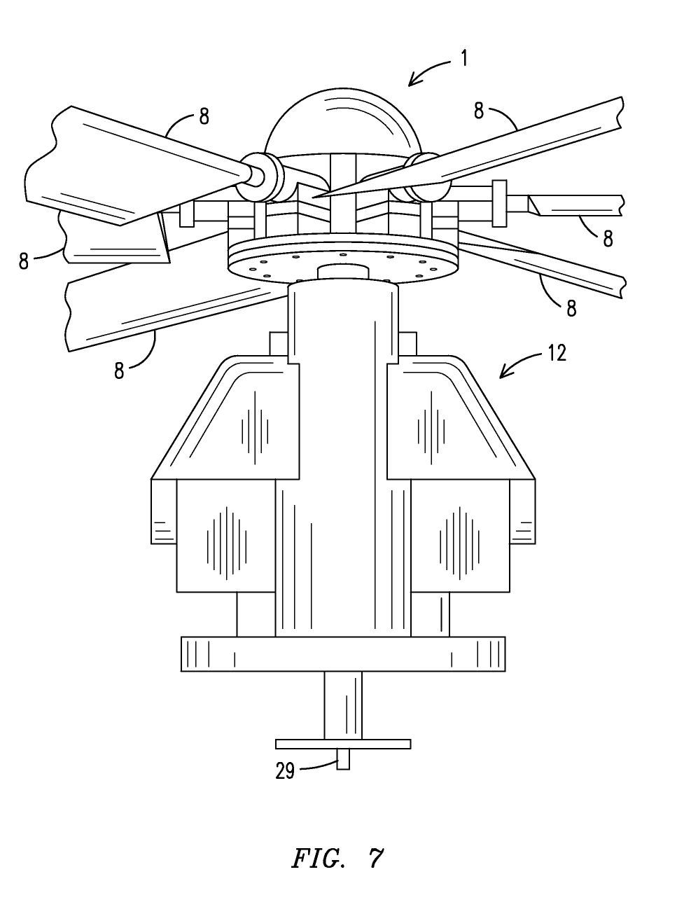

Now referring to FIG. 6, a top partial cutaway view of a speed regulating gear 12 of the present invention having a rack and pinion gear assembly 30 as a guide means is shown. The speed regulating gear 12 comprises a main housing 13 having a telescoping housing 14 extending therefrom. A stationary inner housing 15 acts as a guide for the telescoping housing 14 as the telescoping housing 14 retracts and extends along the inner housing 15. A mounting bracket 16 is located on one end of the telescoping housing 14. The mounting bracket 16 is used for attaching a hub 1 to the speed regulating gear 12, as shown in FIG. 7. A input axle 18, which connects to the mounting bracket 16 extends through the telescoping housing 14, inner housing 15 and through a conical gear 19. A regulating spring 17 located inside of the telescoping housing 14 and inner housing 15 maintains the telescoping housing 14 in an extended position when wind speeds are low and little or no pressure is being exerted on the telescoping housing 14. As wind speeds increase, the telescoping housing 14, input axle 18 and conical gear 19 all retract within the main housing 13. A guide means 20, such as a guide peg 22 and projection 27 having an angled guide slot 21, guide spring 23 or a rack and pinion gear assembly 30, ensures that a sliding gear assembly 26 always stays engaged with the conical gear 19 as the diameter of the conical gear 19 changes according to the position of the conical gear 19. As shown here, the guide means 20 is a rack and pinion gear assembly 30 having a rack gear 24 located on the sliding gear assembly 26, a rack gear 24 located on the telescoping housing 14, and two pinion gears 25 located in-between the rack gears 24. As the telescoping housing 14 retracts inward, the rack and pinion gear assembly 30 forces the sliding gear assembly 26 to slide inward so that the sliding gear assembly 26 stays engaged with the conical gear 19 as the diameter of the conical gear 19 decreases. After the telescoping housing 14 retracts past a certain point, the sliding gear assembly 26 will disengage from the conical gear 19 to prevent any harm to the speed regulating gear 1 and generator. As the telescoping housing 14 extends outward, the rack and pinion gear assembly 30 forces the sliding gear assembly 26 to slide outward so that the sliding gear assembly 26 constantly stays engaged with the conical gear 19 as the diameter of the conical gear 19 increases, as illustrated here. An output gear assembly 28 engages the sliding gear assembly 26 and transfers power from the sliding gear assembly 26 to an output axle 29. The speed regulating gear 12 may be adapted to a upwind or downwind applications by reversing the direction of the conical gear 19.

Finally referring to FIG. 7, a top view of a blade pitch regulating hub 1 mounted on a speed regulating gear 12 is shown. The blade pitch regulating hub 1 automatically feathers and controls the pitch of blades 8 according to wind speed conditions. The speed regulating gear 12 controls the amount of rotational power transferred to an output axle 29, thereby reducing any strain on any generators connected to the output axle 29.

It is to be understood that while a preferred embodiment of the invention is illustrated, it is not to be limited to the specific form or arrangement of parts described and shown herein. It will be apparent to those skilled in the art that various changes may be made without departing from the scope of the invention and the invention is not to be considered limited to what is shown and described in the specification and drawings.

Having thus described my invention, I claim;

1. A blade pitch regulating hub for use in wind driven power generators, said blade pitch regulating hub comprising:
a hub base;
a base gear pivotally attached to the hub base;
a hub wall located on the hub base;
at lease two blade stems that extend through the hub wall;
a stem gear located on each of the at lease two blade stems that engages the base gear; and
a regulating means secured to at least one of the at least two blade stems.

2. The blade pitch regulating hub of claim 1 wherein:
said regulating means is a torsion bar.

3. The blade pitch regulating hub of claim 1 wherein:
said regulating means is a helical spring.

4. The blade pitch regulating hub of claim 1 wherein:
said regulating means is secured to at least two of the at least two blade stems.

5. The blade pitch regulating hub of claim 2 wherein:
said regulating means is secured to at least two of the at least two blade stems.

6. The blade pitch regulating hub of claim 3 wherein:
said regulating means is secured to at least two of the at least two blade stems.

7. The blade pitch regulating hub of claim 1 wherein:
said regulating means is secured to at least one of the at least two blade stems and to the hub wall.

8. The blade pitch regulating hub of claim 2 wherein:
said regulating means is secured to at least one of the at least two blade stems and to the hub wall.

9. The blade pitch regulating hub of claim 3 wherein:
said regulating means is secured to at least one of the at least two blade stems and to the hub wall.

10. A speed regulating gear for use in wind driven power generators, said speed regulating gear comprising:
a main housing;
a telescoping housing that extends out of and retracts into the main housing;
an inner housing that acts a guide for the telescoping housing;
a regulating spring located inside the telescoping housing;
an input axle that passes through the telescoping housing;
a conical gear located on the input axle; and
a sliding gear assembly that engages the conical gear and transfers rotational power from the conical gear to an output gear assembly and an out put axle.

11. The speed regulating gear of claim 10 further comprising:
a guide means that pushes the sliding gear assembly towards the conical gear when the telescoping housing extends out of the main housing and pushes the sliding gear assembly away from the conical gear when the telescoping housing retracts into the main housing.

12. The speed regulating gear of claim 10 wherein:
said guide means comprises at least one projection having a guide slot located on the telescoping housing; and
at least one guide peg located on the sliding gear assembly that engages the guide slot.

13. The speed regulating gear of claim 10 wherein:
said guide means comprises at least on guide spring.

14. The speed regulating gear of claim 10 wherein:
said guide means comprises a rack and pinion gear assembly.

15. The speed regulating gear of claim 14 wherein said rack and pinion gear assembly further comprises:
at least one rack gear located on the telescoping housing;
at least one rack gear located on the sliding gear assembly; and
at least one pinion gear located in-between the at least one rack gear located on the telescoping housing and the at least one rack gear located on the sliding gear assembly that transfers linear motion from the telescoping housing to the sliding gear assembly.

16. A wind driven power generator comprising:
a blade pitch regulating hub;
at least one blade connected to said blade pitch regulating hub;
at least one axle connected to said blade pitch regulating hub; and
a speed regulating gear connected to the at least one axle.

17. The wind driven power generator of claim 16 wherein the blade pitch regulating hub further comprises:
a hub base;
a base gear pivotally attached to the hub base;
a hub wall located on the hub base;
at lease two blade stems that extend through the hub wall;
a stem gear located on each of the at lease two blade stems that engages the base gear; and
a regulating means secured to at least one of the at least two blade stems.

18. The wind driven power generator of claim 17 wherein:
said regulating means is a torsion bar.

19. The wind driven power generator of claim 17 wherein:
said regulating means is a helical spring.

20. The wind driven power generator of claim 17 wherein:
said regulating means is secured to at least two of the at least two blade stems.

21. The wind driven power generator of claim 18 wherein:
said regulating means is secured to at least two of the at least two blade stems.

22. The wind driven power generator of claim 19 wherein:
said regulating means is secured to at least two of the at least two blade stems.

23. The wind driven power generator of claim 17 wherein:
said regulating means is secured to at least one of the at least two blade stems and to the hub wall.

24. The wind driven power generator of claim 18 wherein:
said regulating means is secured to at least one of the at least two blade stems and to the hub wall.

25. The wind driven power generator of claim 19 wherein:
said regulating means is secured to at least one of the at least two blade stems and to the hub wall.

26. The wind driven power generator of claim 17 wherein the speed regulating gear further comprises:
a main housing;
a telescoping housing that extends out of and retracts into the main housing;
an inner housing that acts a guide for the telescoping housing;
a regulating spring located inside the telescoping housing;
an input axle that passes through the telescoping housing;
a conical gear located on the input axle; and
a sliding gear assembly that engages the conical gear and transfers rotational power from the conical gear to an output gear assembly and an out put axle.

27. The wind driven power generator of claim 26 further comprising:
a guide means that pushes the sliding gear assembly towards the conical gear when the telescoping housing extends out of the main housing and pushes the sliding gear assembly away from the conical gear when the telescoping housing retracts into the main housing.

28. The wind driven power generator of claim 26 wherein:
said guide means comprises at least one projection having a guide slot located on the telescoping housing; and
at least one guide peg located on the sliding gear assembly that engages the guide slot.

29. The wind driven power generator of claim 26 wherein:
said guide means comprises at least on guide spring.

30. The wind driven power generator of claim 26 wherein:
said guide means comprises a rack and pinion gear assembly.

31. The wind driven power generator of claim 31 wherein said rack and pinion gear assembly further comprises:
at least one rack gear located on the telescoping housing;
at least one rack gear located on the sliding gear assembly; and
at least one pinion gear located in-between the at least one rack gear located on the telescoping housing and the at least one rack gear located on the sliding gear assembly that transfers linear motion from the telescoping housing to the sliding gear assembly.
